(19) United States
(12) Patent Application Publication
(10) Pub. No.: US 2024/0414518 A1
(43) Pub. Date: Dec. 12, 2024

(54) PER-ENTERPRISE SUBSCRIBER DATA MANAGEMENT IN A MULTI-TENANT NETWORK ENVIRONMENT

(71) Applicant: Cisco Technology, Inc., San Jose, CA (US)

(72) Inventors: Praveen Joseph, San Jose, CA (US); Timothy Peter Stammers, Raleigh, NC (US); Monis Mohammed, Cupertino, CA (US)

(21) Appl. No.: 18/329,834

(22) Filed: Jun. 6, 2023

(51) Int. Cl. H04W 8/18

(52) U.S. Cl. CPC H04W 8/183

(57) ABSTRACT

Provided herein are techniques to provide per-enterprise subscriber data management (SDM) in multi-tenant network environment. In one instance, a method may include obtaining, by an SDM system, input information indicating SDM services requested for an enterprise entity in which the input information includes a multi-tenancy service attribute for the enterprise entity and indicates whether subscriber data for is to be provided on-premise for the enterprise entity. The method may further include identifying a particular SDM service of the SDM system for storing the subscriber data, deploying the particular SDM service via the SDM system, and deploying one or more on-premise SDM services at each of one or more on-premise locations of the enterprise entity for storing the subscriber data based on determining that the subscriber data is to be provided on-premise for the enterprise entity.

### TECHNICAL FIELD

The present disclosure relates to network equipment and services.

### BACKGROUND

Networking architectures have grown increasingly complex in communication environments. In particular, mobile communication networks have grown substantially as end users become increasingly connected to mobile network environments. As the number of mobile users increases, efficient management of communication resources and of users becomes more critical.

### BRIEF DESCRIPTION OF THE DRAWINGS

FIG. 1 is a block diagram of a system that may facilitate per-enterprise subscriber data management in a multi-tenant network environment, according to an example embodiment.

FIG. 2 is a block diagram illustrating various operational features that may be provided via the system of FIG. 1 in order to facilitate per-enterprise subscriber data management in a multi-tenant network environment, according to an example embodiment.

FIGS. 3A and 3B are a message sequence diagram illustrating various example operations that may be performed to facilitate per-enterprise subscriber data management in a multi-tenant network environment, according to an example embodiment.

FIG. 4 is a message sequence diagram illustrating various other example operations that may be performed to facilitate per-enterprise subscriber data management in a multi-tenant network environment, according to an example embodiment.

FIGS. 5A and 5B are a message sequence diagram illustrating various other example operations that may be performed to facilitate per-enterprise subscriber data management in a multi-tenant network environment, according to an example embodiment.

FIG. 6 is a flowchart depicting a method according to an example embodiment.

FIG. 7 is a hardware block diagram of a computing device that may perform functions associated with any combination of operations discussed in connection with techniques described for embodiments herein.

### DETAILED DESCRIPTION

### Overview

Provided herein are techniques through which per-enterprise subscriber data management services may be provided for multiple enterprise entities in a multi-tenant network environment. In at least one embodiment, a computer-implemented method is provided that may include obtaining, by a subscriber data management (SDM) system, input information indicating SDM services requested for an enterprise entity, wherein the input information includes a multi-tenancy service attribute for the enterprise entity and indicates whether subscriber data for the enterprise entity is to be provided on-premise for the enterprise entity; identifying, based on the multi-tenancy service attribute included in the input information, a particular SDM service of the SDM system for storing the subscriber data for the enterprise entity from a plurality of SDM service options provided by the SDM system; deploying the particular SDM service via the SDM system for storing the subscriber data for the enterprise entity; and deploying one or more on-premise SDM services at each of one or more on-premise locations of the enterprise entity for storing the subscriber data based on determining that the subscriber data is to be provided on-premise for the enterprise entity.

### Example Embodiments

Managing multi-tenancy provisioning and storage for subscriber data (e.g., Subscriber Identity Module (SIM) subscriptions) for large numbers (e.g., millions) of subscribers is complex. Typically, large-scale, and correspondingly expensive, subscriber data systems are often dedicated for a single service, such as a consumer (public) cellular mobility network in which all SIM-related subscription and authentication data belongs to and is the responsibility of a single service owner/service provider.

In contrast, a private Fifth Generation (5G)-as-a-Service (5GaaS) offering can support many different partners/service providers and/or end customers (e.g., enterprise entities) that each may have a few hundred to tens of thousands of subscribers/SIMs. For example, a 5GaaS offering/system can be provided by a 5GaaS provider in which the 5GaaS provider may sell/lease Third Generation Partnership Project (3GPP) 5G cellular service to a number of service partners or providers, each of which may in turn sell or otherwise provide 5G cellular service to a number of enterprise entities. In some instances, the 5GaaS provider may also provide 5G cellular service directly to one or more enterprise entities.

The subscriber data for each of different “SIM-sets” that belong to different end customers or enterprise entities (e.g., SIM data for a set of enterprise managed subscribers/wireless devices) are to be accessible only by the ‘owner’ of a given SIM-set in the course of regular operations.

There can be many multi-tenancy considerations, such as managing multi-tenancy credentials, potentially logical and/or physical partitioning of storage and subscriber data, and/or the like that can result in a complex undertaking to provide subscriber data management (SDM) functionality for a 5GaaS offering that is to serve to multiple service partners/providers and multiple enterprise entities.

Further, pre-deploying multiple instances of SDM functionality can be costly and operationally complex. It can also be inefficient, as such pre-deployment of SDM functionality is often based on market forecasts estimating a number of enterprise customers to which a 5GaaS may serve, which can change based on the number of service providers (and their forecasts) regarding the number of enterprise customers that are expected to be served. Thus, it would be advantageous to provide effective techniques through which to address and facilitate different multi-tenancy aspects for subscriber/SIM data provisioning and storage while reducing the service per subscriber cost-to-operate SDM services for multi-tenancy environments involving multiple service partners/providers and multiple enterprises.

Embodiments provided herein may provide a multi-tenant cloud-hosted mobility service via a SDM system that facilitates allocating storage for SDM services or functionality in a manner that ensures subscription data separation between enterprise entities of the mobility service while offering service providers and/or enterprise entities the ability to determine where (in the cloud and/or on-premise) they may want the subscriber data to be stored. Further, embodiments herein may provide capabilities via any combination of Application Programming Interfaces (APIs) and/or Graphical User Interfaces (GUIs) for a managed service partner or provider and/or an enterprise entity (customer) to provide input information regarding enterprise preferences regarding where and in what manner subscription data is to be maintained (e.g., based on various use case scenarios and as constrained by choices offered/available for input and/or selection) in order facilitate per-enterprise subscriber data management in a multi-tenant network environment.

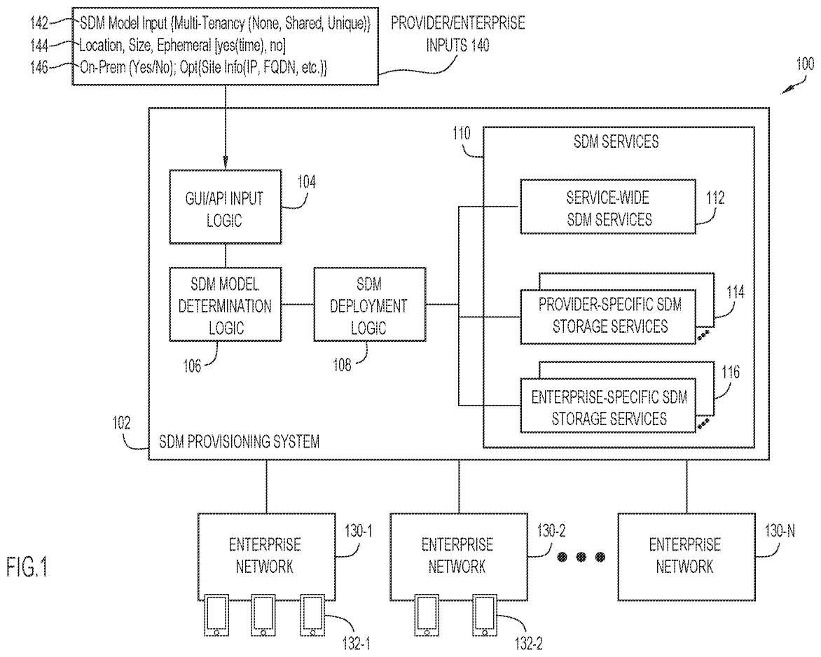

Referring to FIG. 1, FIG. 1 is a block diagram of a system 100 that may facilitate per-enterprise subscriber data management for a multi-tenant network environment, according to an example embodiment. System 100 may include a subscriber data management (SDM) provisioning system 102 that can interface with a number of enterprise networks, such as enterprise networks 130-1, and 130-2, thru 130-N, each of which is considered to be operated by a different corresponding enterprise entity (e.g., business entity, government entity, educational entity, combinations thereof, etc.). Also shown in FIG. 1 are a number of wireless devices, each of which may be considered to be managed by an enterprise entity operating each enterprise network 130-1-130-N. For example, wireless devices 132-1 may be managed by the enterprise entity operating enterprise network 130-1, wireless devices 132-2 may be managed by the enterprise operating enterprise network 130-2, etc. As referred to herein, the terms ‘enterprise entity’ and ‘enterprise’ can be used interchangeably.

SDM provisioning system 102 may include any combination of GUI and/or API (GUI/API) input logic 104, SDM model determination logic 106, and SDM deployment logic to facilitate allocating storage via one or more SDM services 110 provided via SDM provisioning system 102 and, in some instances, on-premise SDM services provided for one or more enterprise networks/enterprise entities (not shown in FIG. 1, discussed in further detail below), in order to store subscriber data for one or more enterprise entities, such an any enterprise entities operating any of enterprise networks 130-1-130-N. In at least one embodiment, the subscriber data stored via SDM services discussed for embodiments herein may include SIM data for one or more subscribers/wireless devices that may be managed by the enterprise entities in which the SIM data can enable wireless devices of a corresponding enterprise entity to connect to a private 5G (P5G) cellular network implemented via a corresponding enterprise site/location for the enterprise network of the corresponding enterprise entity.

In some embodiments, SDM provisioning system 102 may be considered a multi-tenant cloud-hosted mobility service in which SDM services 110 may facilitate various SDM service options that can be considered cloud-hosted SDM services such that any subscriber (SIM) data provisioned/stored/managed via SDM services 110 may be considered for any combination of enterprise entities and/or service providers may be accessible via any of enterprise networks 130-1-130-N.

In various embodiments, subscriber or SIM data for each of one or more subscribers/wireless devices managed by an enterprise entity and may include any combination of an International Mobile Subscriber Identity (IMSI), a Subscription Permanent Identifier (SUPI), a Subscription Concealed Identifier (SUCI), an Integrated Circuit Card Identifier (ICCID) ICCID, security algorithms, authentication/security key(s), etc. along with network identifier metadata that may a Public Land Mobile Network Identifier (PLMN-ID), an Access Point Name (APN) and/or Data Network Name (DNN) for session establishment, operating frequencies, etc. specific to one or more networks to which a subscriber/wireless device is authorized to attach (e.g., a P5G enterprise wireless network for one or more enterprise sites, a public mobile network, etc.).

In accordance with embodiments herein, 5GaaS offerings may include any P5G cellular network discussed herein, which may involve providing any combination of 5G cellular services and, in some instances, may also involve providing Fourth Generation (4G)/Long Term Evolution (LTE) cellular services. Different 4G/LTE/5G cellular offerings may utilize different types of SDM services for facilitating authentication/authorization of subscribers/wireless devices for connection to a given P5G cellular network of a given enterprise. SDM services that may be provided for a 4G/LTE cellular service can involve allocating storage for storing subscriber (SIM) data via an SDM service implemented as a 3GPP Home Subscriber Server (HSS), whereas, SDM services that may be provided for a 5G (or next Generation (nG)) cellular service can involve allocating storage for storing subscriber (SIM) data for an SDM service implemented as a 3GPP Unified Data Management (UDM) entity and Unified Data Repository (UDR) (UDM/UDR). Accordingly, any SDM service discussed for embodiments herein may be implemented as any combination of a 3GPP HSS and/or 3GPP UDM/UDR for storing subscriber (SIM) data and providing SDM services, which may be inclusive as any combination of authentication services, authorization services, and/or any other applicable 3GPP HSS/UDM/UDR service that may be provided for any subscribers/wireless devices of any enterprise entity and/or combination of providers/enterprise entities.

In various embodiments, SDM services 110 provided via SDM provisioning system 102 can facilitate providing various SDM service options that may be available for, supported by, or otherwise provided by SDM provisioning system, such as service-wide SDM services 112, provider-specific SDM services 114, and enterprise-specific SDM services 116, each of which may include storage that can be allocated for utilization/storing subscriber data for each of one or more service providers and/or enterprise entities. In various embodiments, the terms ‘storage’, ‘memory element’, and/or any variation thereof may be inclusive of any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), non-transitory tangible media, non-transitory computer readable storage media software, logic (fixed logic, hardware logic, programmable logic, analog logic, digital logic), hardware, and/or in any other suitable component, device, element, and/or object as may be appropriate that may be used to store, manage, provide, and/or otherwise facilitate the storage of subscriber/SIM data for one or more subscribers/wireless devices. Although not shown in FIG. 1, it is to be understood that SDM services 110 can also include any compute resources (e.g., hardware processors, logic, etc.) that may facilitate implementing any combination of HSS/UDM/UDR services.

In at least one embodiment, service-wide SDM services 112 can include SDM services that can be utilized to serve any combination of different service providers and different enterprise entities with subscriber data (SIM sets) for each service provider/enterprise being stored via storage provided via the service-wide SDM storage services 112.

In at least one embodiment, provider-specific SDM services 114 can include SDM services that can be utilized to serve any combination of different enterprise entities that may be associated with the same service partner or provider. For example, a particular service provider (‘Service Provider 123’) may be an authorized reseller of a 5GaaS offering/functionality facilitated via SDM provisioning system 102 such that the particular service provider or partner can sell or lease such functionality to multiple enterprise entities in which subscriber data for each of the multiple entities can be stored/serviced via a particular provider-specific SDM service provided via SDM provisioning system 102. Thus, multiple different instances of provider-specific SDM services 114 may be provided via SDM provisioning system 102 with each particular instance of a given provider-specific SDM service serving/hosting subscriber data (SIM sets) for each of multiple different enterprises that have contracted services via a same particular service provider/partner (e.g., Enterprise 1, Enterprise 2, and Enterprise 3, each contracting services from Service Provider 123, can have their associated subscriber data stored via a particular provider-specific SDM service that is to provide SDM services to only Service Provider 123).

In at least one embodiment, enterprise-specific SDM services 116 can include SDM services that are individually provided for each of a given enterprise entity or a given service provider and enterprise entity in which each enterprise-specific SDM service that is provided for each of a given enterprise may be isolated, physically and/or logically, from SDM services provided for other enterprise entities. Thus, multiple different instances of enterprise-specific SDM services 116 may be provided via SDM provisioning system with each particular instance of a given enterprise-specific SDM service serving/hosting subscriber data (a SIM set) for a given enterprise entity or a given combination of a service provider and enterprise entity, if applicable that is isolated, physically and/or logically from all other SDM services and SIM sets provided via SDM provisioning system for other enterprise entities and service providers (e.g., service-wide SDM services, provider-specific SDM services, and other enterprise-specific SDM services provided for other enterprise entities).

Different SDM services may be desired by an enterprise and/or provider for a variety of reasons/purposes. For example, selection of a given SDM service may be dependent on an enterprise/service provider desire for complete data isolation for security, country or industry regulatory reasons and/or data sovereignty reasons. Conversely, no conditions may exist that involve a need for data isolation. In some instances, using service provider instances of SDM services may be desirable for management, simplified troubleshooting (e.g., logs could be configured to include the provider/partner name along with other data), and/or other efficiencies. In still some instances, a particular SDM service may be desired to limit exposure to internal service failures by not sharing. In still some instances, a particular SDM service may be desired because a particular industry vertical is to utilize separation but not between enterprises in that vertical. Other variations can be envisioned

Broadly during operation, SDM provisioning system 102 may apply/utilize GUI/API input logic 104, SDM model determination logic 106, and SDM deployment logic 108 to facilitate service provider and/or enterprise provisioning to a given SDM service type based on provider and/or enterprise inputs 140. For example, a service provider or enterprise entity can provide inputs 140 via GUI/API input logic 104 that include various input information including SDM model input information 142, enterprise input information 144, and on-premise input information 146.

In various embodiments, provider/enterprise inputs 140 can include any combination of selections (e.g., radio button selections or the like) of available SDM services, selection of a multi-tenancy service attribute (discussed in further detail below), alpha-numeric inputs (e.g., number or size of subscriber data records to be provided/serviced for a given enterprise entity), and/or any other inputs that may be utilized via one or more GUIs and/or APIs that may facilitate providing/obtaining various input information in order to facilitate various operations of SDM provisioning system 102 in accordance with embodiments herein.

In some embodiments, SDM model input information 142 may be provided (e.g., input) for a given service provider involving SDM service for a given enterprise entity that can include a multi-tenancy service attribute that identifies whether the service provider is to be provided independent, provider-specific SDM services 114 or if the service provider can make use of service-wide SDM services 112. For example, SDM model input information 142 provided for a given service provider and a given enterprise entity including a multi-tenancy service attribute of ‘Shared’ (or similar attribute/indication) can be used to indicate that provider-specific SDM services 114 are to be utilized to serve subscriber data for the given service provider and enterprise entity. In another example, SDM model input information 142 provided for a given service provider for a given enterprise entity including a multi-tenancy service attribute of ‘None’ (or similar attribute/indication, such as ‘service-wide’, ‘service’ etc.) can be used to indicate that there is no multi-tenancy service preference for the service provider/enterprise entity, such that the service attribute indicates that service-wide SDM services 112 can be utilized to serve subscriber data for the given service provider and enterprise entity.

In some embodiments, SDM model input information 142 provided for a given enterprise entity may include a multi-tenancy service attribute of ‘Unique’ (or similar attribute/indication) that can be used to indicate that enterprise-specific SDM services 116 are to be utilized to serve subscriber data for the given enterprise entity (and potentially for a given service provider, if applicable). Similar to the ‘Shared’ and ‘None’ multi-tenancy service attributes discussed above, in some embodiments, SDM model input information 142 can be used to indicate whether an enterprise entity can utilize provider-specific SDM services 114 or global, service-wide SDM services 112.

Enterprise input information 144 can include any combination of location information, subscriber data record number or size information, ephemeral information, security information, jurisdictional information, and/or the like. In various embodiments, location information can include, but not be limited to, address information, region information, corporate site identifying information for an enterprise (with an internal mapping utilized to correlate sites to location), and/or the like. In various embodiments, enterprise input ephemeral information may be used to indicate one or more periods of time (e.g., time of day, specific days, etc.) associated with a ‘life’ certain subscriber data for a given enterprise entity, such that the subscriber data may be considered to be expired after expiration of the period(s) of time and/or may need to be updated. In various embodiments, security information may be used to indicate security access types for a given service provider and/or enterprise entity. Regarding security access types, in some instances a given subscriber may only be served at a specific enterprise site or subset of enterprise sites. In such instances, security access could be used to control which enterprise sites are to have subscriber data for the given subscriber. Hence, the sizing of an enterprise site provided SDM service and whether anything is deployed there can be impacted by various security access aspects. In various embodiments, jurisdictional information may be used to indicate data privacy and/or geo-political considerations that may impact SDM services provided for a given service provider/enterprise entity.

On-premise input information 146 can include an indication (Yes or No) that identifies whether subscriber data for a given enterprise entity is to be provided for one or more on-premise SDM services for one or more on-premise locations or ‘sites’ of a given enterprise entity. In some embodiments, on-premise input information 146 can include location/site identifying information such as Internet Protocol (IP) address information, Fully Qualified Domain Name (FQDN) information, specific location information, such as address, etc., region information, and/or any other identifying information that can be used to identify the one or more on-premise locations/sites at which subscriber data is to be provided for SDM services of a given enterprise network for the enterprise entity. In some embodiments, location/site identifying information for a given enterprise entity can be included in enterprise information 144.

The SDM model input information 142 and, in particular, the multi-tenancy service attribute, along with the enterprise input information 144, and on-premise input information 146 for a given service provider/enterprise entity can be passed from GUI/API input logic 104 to SDM model determination logic 106 in order to identify an appropriate (e.g., cloud-hosted) SDM service provided via SDM provisioning system 102 to utilize for serving subscriber data for the enterprise entity and, if applicable one or more on-premise (e.g., enterprise-hosted) SDM services for one or more enterprise locations/site to utilize for serving subscriber data the enterprise entity. Once identified, SDM deployment logic 108 can facilitate deploying SDM service instances and allocating storage for the subscriber data for the enterprise entity via the identified SDM service instance(s) at the desired scale (e.g., number/size of subscriber data records) and deployment locations (e.g., cloud-hosted via SDM provisioning system 102 and, if applicable, enterprise-hosted) in accordance with embodiments herein.

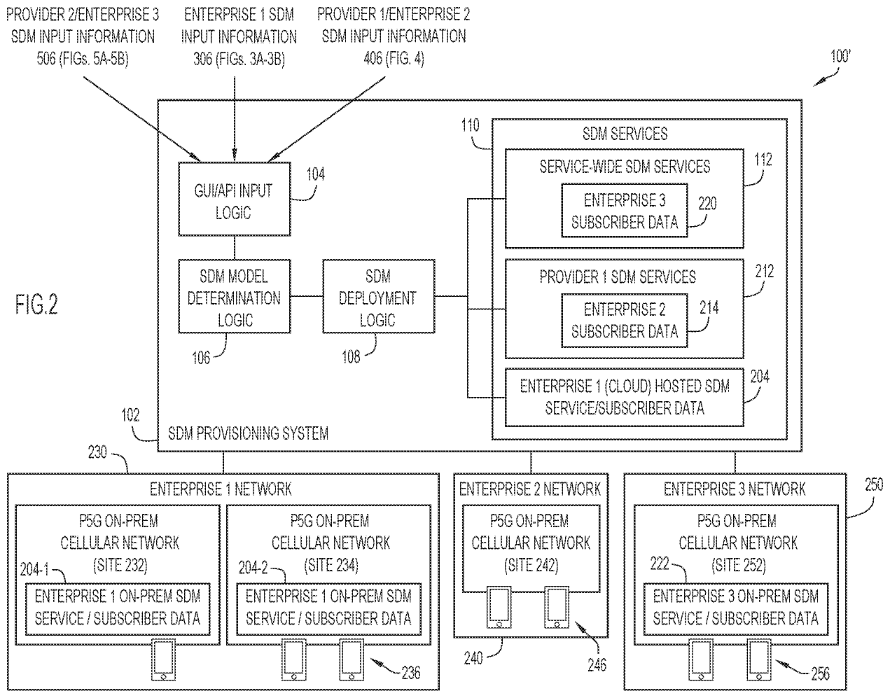

Consider various examples of different SDM services that may be provided for different service providers/enterprise entities based on various service provider/enterprise inputs that can be provided for SDM provisioning system 102 as shown via FIG. 2, which is a block diagram illustrating a system 100′ in which different SDM services can be provided via SDM provisioning system 102 for each of: an enterprise 1 that is operating an enterprise 1 network 230 in which a P5G cellular network is provided for each of a site 232 and a site 234; a service provider 1 that has contracted with an enterprise 2 to provide a P5G cellular network at a site 242 of an enterprise 2 network 240; and a service provider 2 that has contracted with an enterprise 3 to provide a P5G cellular network at a site 252 of an enterprise 3 network 250.

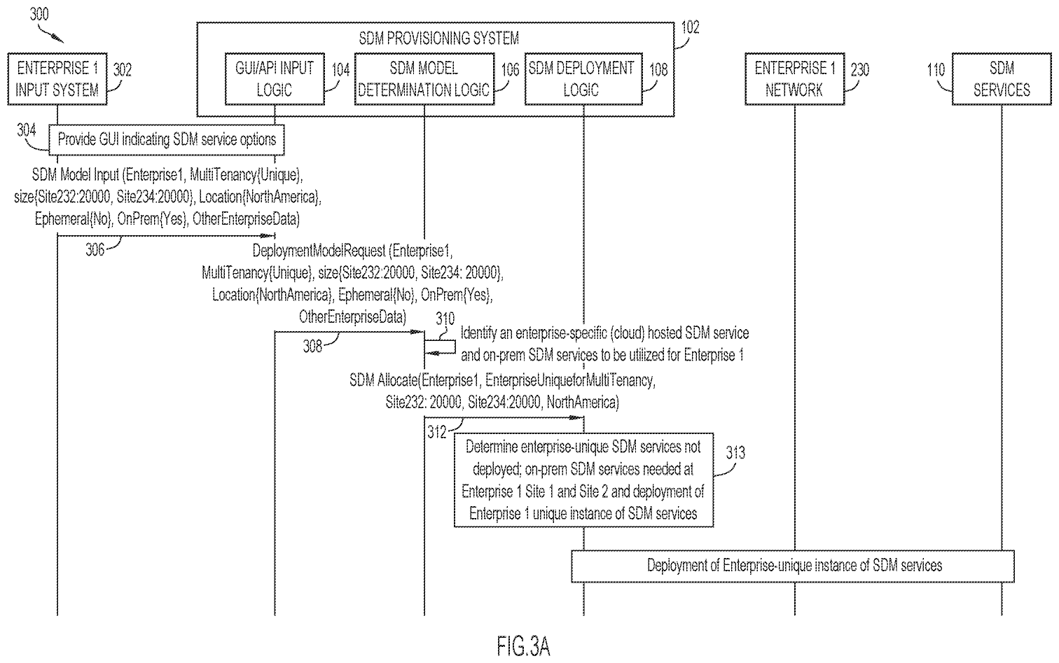

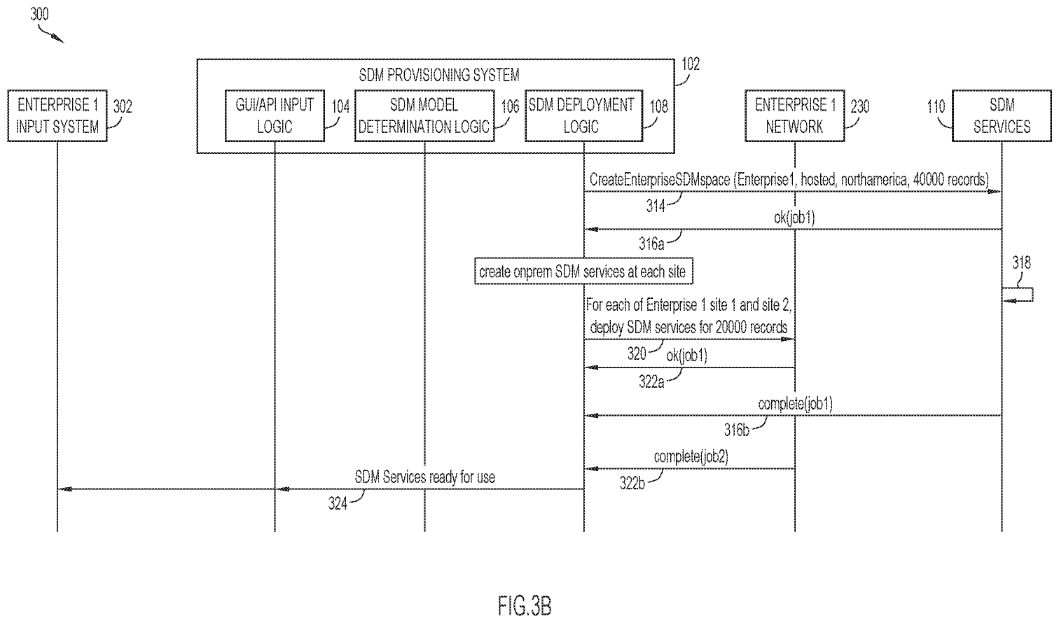

Various example details illustrated for FIG. 2 are discussed herein with reference to each of respective FIGS. 3A, 3B, 4, 5A, and 5B, each of which are respective message sequence diagrams illustrating various respective example operations 300, 400, and 500 that may be performed to facilitate per-enterprise subscriber data management in a multi-tenant network environment, according to various example embodiments.

For example, each of FIGS. 3A and 3B, FIG. 4, and FIGS. 5A and 5B include SDM provisioning system 102 including GUI/API input logic 104, SDM model determination logic 106, and SDM deployment logic 108 and also includes SDM services 110 that can be provisioned to provide appropriate SDM services based on various input information discussed for each of FIGS. 3A-3B, FIG. 4, and FIGS. 5A-5B in which different SDM service options may be identified based on the input information. For each of FIGS. 2, 3A-3B, 4, and 5A-5B, it is assumed that all network elements (e.g., servers, cables, etc.) and network connectivity has been provided for system 100′ and each of enterprise 1 network 230, enterprise 2 network 240, and enterprise 3 network 25 such that SDM provisioning system 102 can interface with each of the enterprise networks and, if applicable, SDM service(s) to be utilized at one or more site(s) of the enterprise networks.

With reference to FIGS. 3A and 3B involving operations 300, FIGS. 3A and 3B further include an enterprise 1 input system 302 and enterprise 1 network 230. In various embodiments, enterprise 1 input system 302 include any combination of a computer/terminal, gateway, etc. that may facilitate providing displaying, selecting, inputting, and/or otherwise interacting with GUI information provided by SDM provisioning system 102 to facilitate enterprise 1 (e.g., a network administrator or the like) providing input information to SDM provisioning system 102 via GUI/API input logic 104.

As shown at 304, consider that a GUI is provided for enterprise 1 input system via GUI/API input logic 104 that indicates various SDM service options that can be facilitated via SDM provisioning system 102. It is to be understood that the enterprise can analyze its desired use cases, number of subscriber data records, etc. in order to determine selections/input information to be provided to SDM provisioning system 102. Further, it is to be understood that the GUI can include any user interface features, fields, radio buttons, selection buttons, etc. as may be understood in the art that can be used to facilitate inputting/receiving indications of SDM service options in accordance with any embodiments herein. Other inputs may be provided in some instances. For example, other input information can be provided for setting up radio access networks, non-SDM components, etc. for facilitating P5G on-prem cellular network(s) for an enterprise.

As shown at 306, consider that enterprise 1 provides input information including SDM model input information that identifies enterprise 1 and includes a multi-tenancy service attribute set to ‘Unique’ that indicates that enterprise-specific SDM services are to be utilized to serve subscriber data for enterprise 1. Further, the input information provided at 306 can include enterprise input information for enterprise 1 including size information that identifies site 232 at which 20000 subscriber data records are to be serviced and site 234 at which 20000 subscriber data records are to be serviced (thus, 40000 total subscriber records are to be serviced for enterprise 1), location information indicating North America, and ephemeral information set to ‘No’ indicating that there is to be no expiration/life associated with the subscriber data managed for enterprise 1. Further, the input information provided at 306 can include on-premise input information set to ‘Yes’ that indicates that the subscriber data for enterprise 1 is to be provided for SDM services at each of site 232 and 234 of enterprise 1 network 230. Other input information and/or enterprise 1 data can be provided at 306, such as security information, jurisdictional information, etc. in accordance with embodiments herein.

The input information is obtained by GUI/API input logic 104 and provided to SDM model determination logic 106, as shown at 308 via a deployment model request message. As shown at 310, SDM model determination logic 106 identifies, based in the input information and, in particular, the multi-tenancy service attribute that is set to ‘Unique’, that an enterprise-specific (cloud) hosted SDM service is to be utilized from the different SDM services 110 service options available via SDM provisioning system 102 in order serve the subscriber data for enterprise 1. The SDM model determination logic 106 can further identify at 310, based on the on-premise input information set to ‘Yes’ that the subscriber data for enterprise 1 is to be provided for an on-premise SDM service provided at each of site 232 and 234 of enterprise 1 network 230.

Based on identifying the SDM services to be utilized for enterprise 1 at 310, SDM model determination logic 106 can trigger SDM deployment logic 108, as shown at 312, to provide the identified SDM services. For example, based on the triggering, SDM deployment logic 108 can determine whether an enterprise-specific SDM service is already deployed/allocated for enterprise 1 and also determine that on-premise SDM services are to be utilized for site 232 and 234, as shown at 313.

Continuing to FIG. 3B, to provide the identified SDM services, as shown at 314 and 318, SDM deployment logic 108 can facilitate deployment of an enterprise 1 (cloud) hosted SDM service 204 (as shown in FIG. 2) for storing the subscriber data for enterprise 1 via SDM services 110 by creating or allocating storage space for the enterprise 1 (cloud) hosted SDM service 204, which may include instantiating, as generally illustrated at 318, the corresponding enterprise 1 (cloud) hosted SDM service 204 (e.g., as any of a 3GPP HSS/UDM/UDR) via any combination of compute/storage resources of SDM provisioning system 102/SDM services 110 for storing the subscriber data for enterprise 1. It is to be understood that deployment of the enterprise 1 (cloud) hosted SDM service 204 can involve any operations now known in the art or hereinafter developed for providing any combination of HSS/UDM/UDR services at the desired scale. As shown at 316a, a response can be provided to SDM deployment logic indicating the allocation request for the enterprise 1 (cloud) hosted SDM service 204 for enterprise 1 was received. Thereafter, upon completion of the instantiation/allocation of storage for the enterprise 1 (cloud) hosted SDM service 204, an indication of successful completion of the instantiation/allocation of the storage/enterprise 1 (cloud) hosted SDM service 204 is provided to SDM deployment logic 108, as shown at 316b.

Further to provide the identified SDM services, as shown at 320, SDM deployment logic 108 can also facilitate deployment of each of an enterprise 1 on-premise SDM service 204-1 and 204-2 for storing for the subscriber data for enterprise 1 to which corresponding responses can be provided at 322a and 322b indicating successful completion of the instantiation/allocation of the enterprise 1 on-premise SDM services 204-1 and 204-2 at each of site 232 and 234 for enterprise 1 network 230. It is to be understood that deployment of the enterprise 1 on-premise SDM services 204-1 and 204-1 can involve any operations now known in the art or hereinafter developed for providing any combination of HSS/UDM/UDR services at the desired scale and deployment locations/sites.

Upon completing instantiation/allocation of the enterprise-specific SDM service 204 and each of the enterprise 1 on-premise SDM service 204-1 and 204-2 a message can be provided to GUI/API input logic 104 indicating that the SDM services for enterprise 1 are ready for use, as shown at 324, in which such information can be provided to the enterprise 1 input system 302.

Any subscribers/wireless devices managed by enterprise 1, such as any of wireless devices 236 shown in FIG. 2 may connect to any P5G on-prem cellular network for any of site 232 and 234 using either the enterprise-specific (cloud) hosted SDM service 204 and corresponding subscriber data or enterprise 1 on-premise SDM services 204-1 or 204-2 (as appropriate) and corresponding subscriber data for registration and session establishment based on a subscription identifier for each wireless device 236 (e.g., IMSI, SUPI, etc.) and potentially on-premise specific configurations that may be configured for site 232 and/or 234. For example, in some instances, subscription identifying information, such as specific IMSIs/SUPIs, etc. for certain enterprise subscribers for an enterprise could be used to steer registration/session establishment for the subscribers to utilize the enterprise-specific (cloud) hosted SDM service 204 even if subscription data for the subscribers is present in an on-premise SDM service.

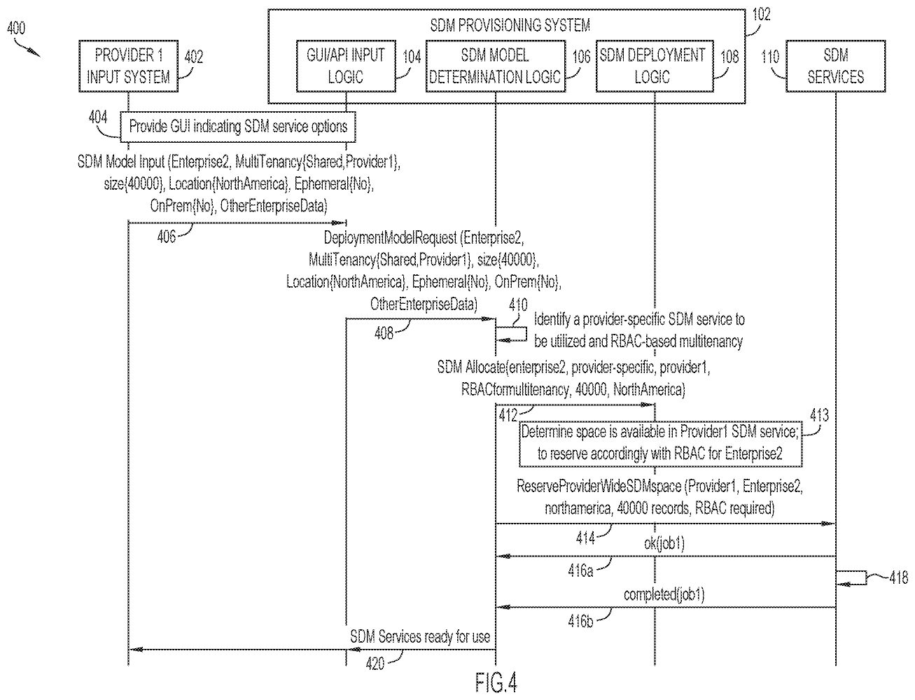

Next, consider FIG. 4 involving operations 400 in which FIG. 4 further includes a provider 1 input system 402. In various embodiments, provider 1 input system 402 include any combination of a computer/terminal, gateway, etc. that may facilitate providing displaying. selecting, inputting, and/or otherwise interacting with GUI information provided by SDM provisioning system 102 to facilitate enterprise 1 (e.g., a network administrator or the like) providing input information to SDM provisioning system 102 via GUI/API input logic 104.

As shown at 404, consider that a GUI is provided for provider 1 input system via GUI/API input logic 104 that indicates various SDM service options that can be facilitated via SDM provisioning system 102. It is to be understood that the enterprise can analyze its desired use cases, number of subscriber data records, etc. in order to determine selections/input information to be provided to SDM provisioning system 102.

As shown at 406, consider that provider 1 provides input information including SDM model input information that identifies enterprise 2 and includes a multi-tenancy service attribute set to ‘Shared’ and identifying service provider 1 that indicates that provider-specific SDM services for service provider 1 are to be utilized to serve subscriber data for enterprise 2. Further, the input information provided at 406 can include enterprise input information for enterprise 2 including size information that identifies 40000 subscriber data records are to be serviced for enterprise 2, location information indicating North America, and ephemeral information set to ‘No’ indicating that there is to be no expiration/life associated with the subscriber data managed for enterprise 2. Further, the input information provided at 606 can include on-premise input information set to ‘No’ indicating that the subscriber data for enterprise 1 is not to be provided for SDM services at an enterprise site 242 of enterprise 2 network 240. Other input information and/or enterprise 2 data can be provided at 406, such as security information, jurisdictional information, etc. in accordance with embodiments herein.

The input information is obtained by GUI/API input logic 104 and provided to SDM model determination logic 106, as shown at 408 via a deployment model request message. As shown at 410, SDM model determination logic 106 identifies, based in the input information and, in particular, the multi-tenancy service attribute that is set to ‘Shared’ and identifies service provider 1, that a (cloud-hosted) provider-specific SDM service is to be utilized from the different SDM services 110 service options available via SDM provisioning system 102 in order serve the subscriber data for enterprise 2. The SDM model determination logic 106 further identifies that Role-Based Access Control (RBAC) for multitenancy is to be utilized for the provider-specific SDM service.

If the decision is made by a provider/partner to use a provider-specific SDM service across multiple enterprises, that means that RBAC is needed across that service to ensure that a particular enterprise can only view/act on the subscription data that it owns. The provider/partner can see the data of all the enterprises with which they may have a relationship (e.g., be partnered with). RBAC is access control based on user credentials that determines which action(s) can be taken on which data sets. The user credentials can be mapped to a role as part of the system configuration.

Based on identifying the SDM services to be utilized for enterprise 2 at 408, SDM model determination logic 106 can trigger SDM deployment logic 108, as shown at 412, to provide the identified SDM service. For example, based on the triggering, SDM deployment logic 108 can determine whether a provider-specific SDM service is already deployed/allocated for service provider 1 and also determine whether storage space is available in the provider-specific SDM service for the 40000 enterprise 2 subscriber data records, as shown at 413.

For the example of FIG. 4, consider that a provider 1 SDM service 212 (as shown in FIG. 2) has already been provided/deployed via SDM services 110 such that to provide the identified provider-specific SDM service, as shown at 414 and 418, SDM deployment logic 108 can facilitate reserving or otherwise allocating storage space of the provider 1 SDM service 212 for storing the subscriber data for enterprise 2, shown in FIG. 2 as enterprise 2 subscriber data 214. The operations performed by the SDM deployment logic 108 can include determining whether space is available in the provider 1 SDM service 212 to facilitate storage of the 40000 enterprise 2 subscriber data records. In some embodiments, the determination at 413 may result in determining that there is not currently enough space available in the provider's SDM service to facilitate storing an amount of subscriber data records (e.g., by tracking/monitoring space availability of the provider 1 SDM service 212, by querying SDM services 112 regarding available space of the provider 1 SDM service, etc.). In such embodiments, the operations at 414 may include increasing the available space for the provider 1 SDM service 212 to facilitate storage of the 40000 enterprise 2 subscriber data records.

As shown at 416a, a response can be provided to SDM deployment logic indicating the request for reserving storage space for the provider 1 SDM service 212 for the subscriber data for enterprise 2 was received. Thereafter, upon completion of the reservation of storage space for the subscriber data (at 418) via enterprise 2 subscriber data 214 for provider 1 SDM service 212, an indication of successful completion of the reservation is provided to SDM deployment logic 108. as shown at 416b and a message can be provided to the GUI/API input logic 104, as shown at 420, indicating that the SDM services for enterprise 2 are ready for use.

Any subscribers/wireless devices managed by enterprise 2, such as any of wireless devices 246 shown in FIG. 2 may connect to the P5G on-prem cellular network for site 242 of enterprise 2 network 240 using the provider 1 SDM service 212 and corresponding enterprise 2 subscriber data 214.

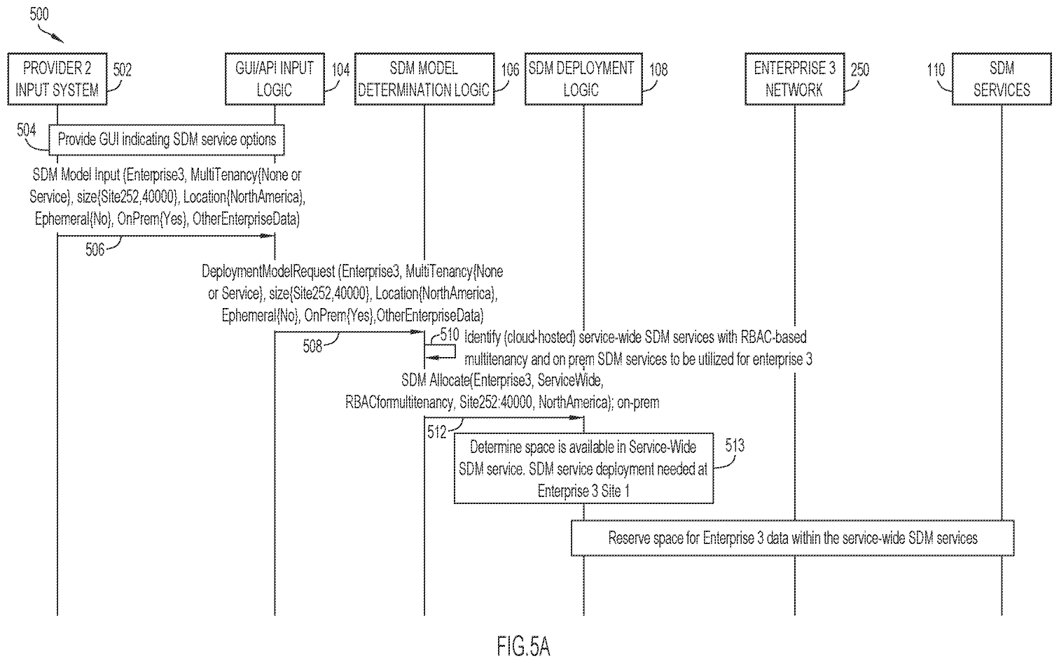

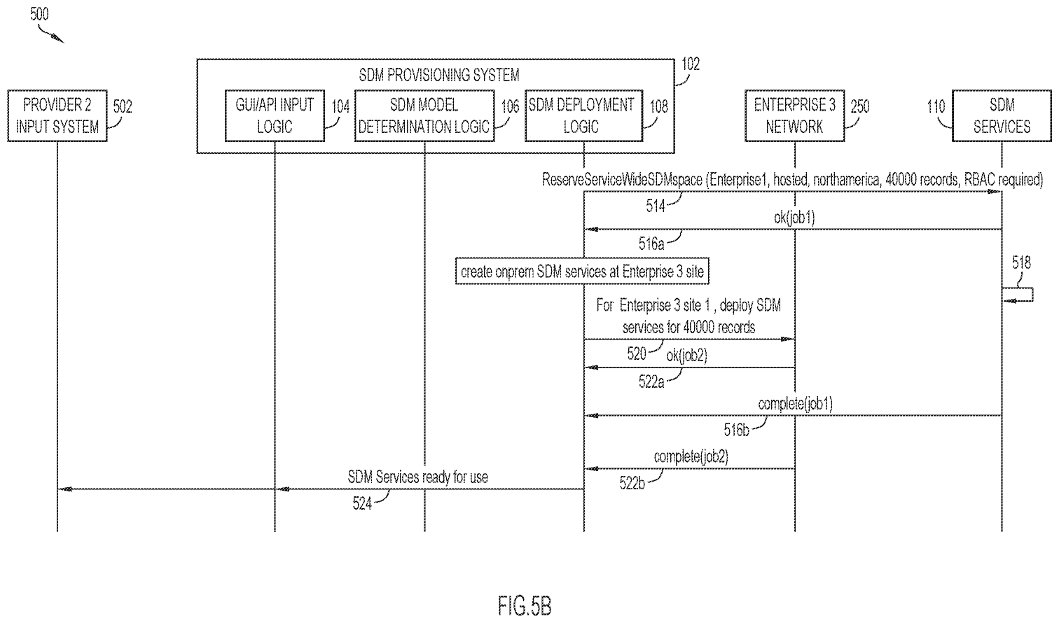

Next, consider FIGS. 5A and 5B, involving operations 500 in which FIGS. 5A and 5B further include a provider 2 input system 502 and enterprise 3 network 250. In various embodiments, provider 2 input system 502 include any combination of a computer/terminal, gateway, etc. that may facilitate providing displaying, selecting, inputting, and/or otherwise interacting with GUI information provided by SDM provisioning system 102 to facilitate enterprise 1 (e.g., a network administrator or the like) providing input information to SDM provisioning system 102 via GUI/API input logic 104.

As shown at 504, consider that a GUI is provided for provider 2 input system via GUI/API input logic 104 that indicates various SDM service options that can be facilitated via SDM provisioning system 102. It is to be understood that the enterprise can analyze its desired use cases, number of subscriber data records, etc. in order to determine selections/input information to be provided to SDM provisioning system 102.

As shown at 506, consider that provider 2 provides input information including SDM model input information that identifies enterprise 3 and includes a multi-tenancy service attribute set to ‘None’ or ‘Service’ that indicates that service-wide SDM services 112 are to be utilized to serve subscriber data for enterprise 3. Further, the input information provided at 506 can include enterprise input information for enterprise 3 including size information that identifies site 252 at which 40000 subscriber data records are to be serviced, location information indicating North America, and ephemeral information set to ‘No’ indicating that there is to be no expiration/life associated with the subscriber data managed for enterprise 3. Further, the input information provided at 506 can include on-premise input information set to ‘Yes’ that indicates that the subscriber data for enterprise 1 is to be provided for SDM services site 252 of enterprise 3 network 250. Other input information and/or enterprise 3 data can be provided at 506, such as security information, jurisdictional information, etc. in accordance with embodiments herein.

The input information is obtained by GUI/API input logic 104 and provided to SDM model determination logic 106, as shown at 508 via a deployment model request message. As shown at 510, SDM model determination logic 106 identifies, based in the input information and, in particular, the multi-tenancy service attribute that is set to ‘None’ or ‘Service’, that the service-wide SDM services 110 and RBAC-based multitenancy are to be utilized from the different SDM services 110 service options available via SDM provisioning system 102 in order serve the subscriber data for enterprise 3. The SDM model determination logic 106 can further identify at 510, based on the on-premise input information set to ‘Yes’ that the subscriber data for enterprise 1 is to be provided for an on-premise SDM service provided at site 252 of enterprise 3 network 250.

Based on identifying the SDM services to be utilized for enterprise 1 at 510, SDM model determination logic 106 can trigger SDM deployment logic 108, as shown at 512, to provide the identified SDM services. For example, based on the triggering, SDM deployment logic 108 can determine that storage space is available via the service-wide SDM services 112 for storing the enterprise 3 subscriber data and also determine that on-premise SDM services are to be utilized for site 252, as shown at 513.

To provide the identified SDM services, as shown at 514 and 518 for FIG. 5B, SDM deployment logic 108 can facilitate reserving or otherwise allocating storage space of the service-wide SDM services 112 for storing the subscriber data for enterprise 3, shown in FIG. 2 as enterprise 3 subscriber data 220. The operations performed by the SDM deployment logic 108 can include determining whether space is available in the service-wide SDM services 112 to facilitate storage of the 40000 enterprise 3 subscriber data records. In some embodiments, the determination at 513 may result in determining that there is not currently enough space available in the service-wide SDM services to facilitate storing an amount of subscriber data records. In such embodiments, the operations at 514 may include increasing the available space for the service-wide SDM services 112 to facilitate storage of the 40000 enterprise 3 subscriber data records. As shown at 516a, a response can be provided to SDM deployment logic indicating the request for reserving storage space for the service-wide SDM services for the subscriber data for enterprise 3 was received. Thereafter, upon completion of the reservation of storage space for the subscriber data (at 518) via enterprise 3 subscriber data 220 for the service-wide SDM services 112, an indication of successful completion of the reservation is provided to SDM deployment logic 108. as shown at 516b.

Further to provide the identified SDM services, as shown at 520, SDM deployment logic 108 can also facilitate deployment of each of an enterprise 3 on-premise SDM service 222 for storing for the subscriber data for enterprise 3 to which corresponding responses can be provided at 522a and 522b indicating successful completion of the instantiation/allocation of the enterprise 3 on-premise SDM service 222 at site 252 for enterprise 3 network 250. It is to be understood that deployment of the enterprise 1 on-premise SDM service 222 can involve any operations now known in the art or hereinafter developed for providing any combination of HSS/UDM/UDR services at the desired scale and deployment locations/sites.

Upon completing instantiation/allocation of the enterprise 3 subscriber data 220 for the service-wide SDM services 112 and the enterprise 3 on-premise SDM service 222 a message can be provided to GUI/API input logic 104 indicating that the SDM services for enterprise 1 are ready for use, as shown at 524, in which such information can be provided to the provider 2 input system 502.

Any subscribers/wireless devices managed by enterprise 3, such as any of wireless devices 256 shown in FIG. 2 may connect to the P5G on-prem cellular network for site 252 using either the system-wide SDM services 112 and corresponding enterprise 3 subscriber data 220 or the enterprise 3 on-premise SDM service 222 and corresponding subscriber data for registration and session establishment based on a subscription identifier for each wireless device 236 (e.g., IMSI, SUPI, etc.) and potentially on-premise specific configurations that may be configured for site 252.

It is to be understood that the example operations discussed for FIGS. 3A, 3B, 4, 5A, and 5B can be extended to encompass other SDM models. Once the ability to deploy different SDM complexes/services is possible, as enabled by embodiments herein, it may be possible to select/provide other SDM solution implementations that can be tailored to different use cases (e.g., simplified SDM services for some use cases, full-feature consumer mobile SP-style SDM services for other use cases, etc.).

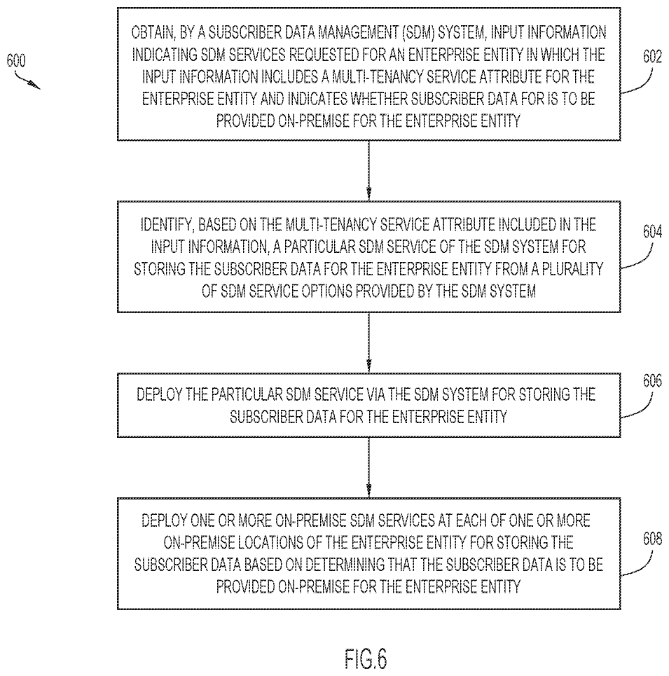

Referring to FIG. 6, FIG. 6 is a flowchart depicting a method according to an example embodiment. In at least one embodiment, method 600 may be associated with techniques that may be utilized to facilitate per-enterprise subscriber data management in a multi-tenant network environment, according to an example embodiment. In various embodiments, method 600 may be performed by a computing device or combination of computing devices as discussed for embodiments herein, such as SDM provisioning system 102.

As shown at 602, the method may include obtaining, by a subscriber data management (SDM) system (e.g., SDM provisioning system 102), input information indicating SDM services requested for an enterprise entity in which the input information includes a multi-tenancy service attribute for the enterprise entity and indicates whether subscriber data for is to be provided on-premise for the enterprise entity.

At 604, the method may include identifying, based on the multi-tenancy service attribute included in the input information, a particular SDM service of the SDM system for storing the subscriber data for the enterprise entity from a plurality of SDM service options provided by the SDM system. At 606, the method may include deploying the particular SDM service via the SDM system for storing the subscriber data for the enterprise entity. At 608, the method may include deploying one or more on-premise SDM services at each of one or more on-premise locations of the enterprise entity for storing the subscriber data based on determining that the subscriber data is to be provided on-premise for the enterprise entity.

Accordingly, embodiments herein may provide the granularity of multi-tenancy for SDM services along with different use-type(s), location(s), scale, life, etc. to facilitate different SDM services based on different SDM service options that may be identified by a service provider and/or enterprise entity such that, at provisioning time, logic provided via SDM provisioning system 102 can identify corresponding patterns or SDM services to be provided to service subscriber data for a given service provider/enterprise entity. Upon identifying the patterns, SDM services, etc., the corresponding SDM services can be deployed utilizing any network function (e.g., HSS/UDM/UDR) deployment techniques via SDM provisioning system 102. In some instances, embodiments herein may enable other actions to be performed for SDM services, such as freezing-in-place, deleting, migrating, etc. SDM services and/or subscriber data for one or more SDM deployments.

Thus, embodiments herein may facilitate a multi-tenant cloud hosted mobility service that can ensure subscription data separation between enterprises/customers of a given SDM service whilst offering the enterprises/customers the ability to determine where they wish the subscriber data to be maintained/serviced. Therefore, in various embodiments, a capability, in the form of GUIs/APIs for a managed service partner or provider, can be provided to determine where an enterprise customer's subscription data can be held in which the determination can be based on a combination of use-case preferences and/or enterprise customer preferences constrained by the choices or SDM service options provided via SDM provisioning system 102.

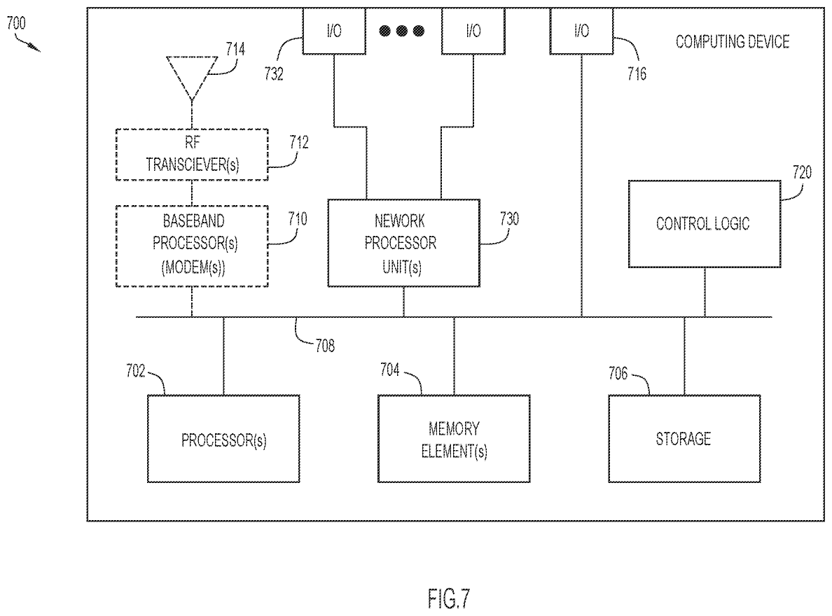

Referring to FIG. 7, FIG. 7 illustrates a hardware block diagram of a computing device 700 that may perform functions associated with operations discussed herein in connection with the techniques depicted in FIGS. 1, 2, 3A, 3B, 4, 5A, 5B, and 6. In various embodiments, a computing device, apparatus, or system such as computing device 700 or any combination of computing devices 700, may be configured as any entity/entities as discussed for the techniques depicted in connection with operations illustrated/discussed for various embodiments herein, such as, SDM provisioning system 102, enterprise 1 input system 302, provider 1 input system 402, provider 2 input system and/or any other network function, element, and/or system discussed for any embodiments herein.

In at least one embodiment, the computing device 700 may be any apparatus that may include one or more processor(s) 702, one or more memory element(s) 704, storage 706, a bus 508, one or more network processor unit(s) 730 interconnected with one or more network input/output (I/O) interface(s) 732, one or more I/O interface(s) 716, and control logic 720. In various embodiments, instructions associated with logic for computing device 700 can overlap in any manner and are not limited to the specific allocation of instructions and/or operations described herein.

For embodiments in which computing device 700 may be implemented as any device capable of wireless communications (e.g., a gNB, a wireless device, etc.), computing device 700 may further include at least one baseband processor or modem 710, one or more radio RF transceiver(s) 712 (e.g., any combination of RF receiver(s) and RF transmitter(s)), one or more antenna(s) or antenna array(s) 714.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa) or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 730 may enable communication between computing device 700 and other systems, entities, etc., via network I/O interface(s) 732 (wired and/or wireless) to facilitate operations discussed for various embodiments described herein. In various embodiments, network processor unit(s) 730 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 732 can be configured as one or more Ethernet port(s), Fibre Channel ports, any other I/O port(s), and/or antenna(s)/antenna array(s) now known or hereafter developed. Thus, the network processor unit(s) 730 and/or network I/O interface(s) 732 may include suitable interfaces for receiving, transmitting, and/or otherwise communicating data and/or information (wired and/or wirelessly) in a network environment.

I/O interface(s) 716 allow for input and output of data and/or information with other entities that may be connected to computing device 700. For example, I/O interface(s) 716 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 700 is implemented as a wireless device or any apparatus capable of wireless communications, the RF transceiver(s) 712 may perform RF transmission and RF reception of wireless signals via antenna(s)/antenna array(s) 714, and the baseband processor or modem 710 performs baseband modulation and demodulation, etc. associated with such signals to enable wireless communications for computing device 700.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include obtaining. by a subscriber data management (SDM) system, input information indicating SDM services requested for an enterprise entity, wherein the input information includes a multi-tenancy service attribute for the enterprise entity and indicates whether subscriber data for the enterprise entity is to be provided on-premise for the enterprise entity; identifying, based on the multi-tenancy service attribute included in the input information, a particular SDM service of the SDM system for storing the subscriber data for the enterprise entity from a plurality of SDM service options provided by the SDM system; deploying the particular SDM service via the SDM system for storing the subscriber data for the enterprise entity; and deploying one or more on-premise SDM services at each of one or more on-premise locations of the enterprise entity for storing the subscriber data based on determining that the subscriber data is to be provided on-premise for the enterprise entity.

In one instance, based on the multi-tenancy service attribute indicating a unique SDM service for storing the subscriber data for the enterprise entity, the deploying includes providing the particular SDM service that is a physically or logically isolated SDM service that is to serve only the subscriber data for the enterprise entity. In one instance, based on the multi-tenancy service attribute indicating a shared SDM service for the subscriber data for the enterprise entity, the deploying includes providing the particular SDM service that is a shared SDM service that is to serve the enterprise entity and one or more other different enterprise entity for a same service provider.

In one instance, based on the multi-tenancy service attribute indicating system that there is no multi-tenancy SDM service preference for the enterprise entity, the deploying includes providing the particular SDM service that is to serve the enterprise entity and any other different enterprise entity for any service providers.

In one instance, the input information further indicates a number of subscribers associated with the subscriber data for the enterprise entity. In one instance, providing the particular SDM service via the SDM system includes allocating or increasing storage for the subscriber data for the enterprise entity via the particular SDM service of the plurality of SDM services of the SDM system based on the number of subscribers indicated in the input information. In one instance, the input information further indicates an expiration time for the subscriber data for the enterprise entity. In one instance, the input information further indicates on-premise location information for the one or more on-premise locations of the enterprise entity at which the subscriber data is to be provided for one or more on-premise SDM services of the enterprise entity. In one instance, the subscriber data is Subscriber Identification Module (SIM) data for a plurality of subscribers of the enterprise entity. In one instance, the input information is obtained via at least one of a graphical user interface (GUI) or an application programming interface (API).

Accordingly, embodiments herein may facilitate cost-effective techniques for providing SDM services via a variety of possible SDM service options that can provide for achieving multi-tenancy by logically and/or physically separating enterprise entities to SDM service instances, when needed, that may be specific to the services/preferences of the enterprise entities and/or service providers. The feature set of a specific SDM service instance (e.g., enterprise-specific, provider-specific, service-wide, etc.) may, in some instances, be implemented as a reduced set of features with less complexity, as may be appropriate for the given SDM service(s) to be used by a given enterprise entity/service provider. Such factors may facilitate reduced costs for infrastructure, licensing, and/or day-to-day operations. Additionally, the day-to-day access management for a given SDM service can be simplified given the scope of the SDM service provided for a customer, enterprise, and/or service provider/partner. Additionally, embodiments herein may facilitate reducing the impact of configuration errors when setting up/providing access management hierarchies in comparison to the manual configuration processes that are often utilized for other SDM scenarios.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, clement, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., clement, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by a subscriber data management (SDM) system, input information indicating SDM services requested for an enterprise entity, wherein the input information includes a multi-tenancy service attribute for the enterprise entity and indicates whether subscriber data for the enterprise entity is to be provided on-premise for the enterprise entity;
identifying, based on the multi-tenancy service attribute included in the input information, a particular SDM service of the SDM system for storing the subscriber data for the enterprise entity from a plurality of SDM service options provided by the SDM system;
deploying the particular SDM service via the SDM system for storing the subscriber data for the enterprise entity; and
deploying one or more on-premise SDM services at each of one or more on-premise locations of the enterprise entity for storing the subscriber data based on determining that the subscriber data is to be provided on-premise for the enterprise entity.

2. The method of claim 1, wherein based on the multi-tenancy service attribute indicating a unique SDM service for storing the subscriber data for the enterprise entity, the deploying includes providing the particular SDM service that is a physically or logically isolated SDM service that is to serve only the subscriber data for the enterprise entity.

3. The method of claim 1, wherein based on the multi-tenancy service attribute indicating a shared SDM service for the subscriber data for the enterprise entity, the deploying includes providing the particular SDM service that is a shared SDM service that is to serve the enterprise entity and one or more other different enterprise entity for a same service provider.

4. The method of claim 1, wherein based on the multi-tenancy service attribute indicating system that there is no multi-tenancy SDM service preference for the enterprise entity, the deploying includes providing the particular SDM service that is to serve the enterprise entity and any other different enterprise entity for any service providers.

5. The method of claim 1, wherein the input information further indicates a number of subscribers associated with the subscriber data for the enterprise entity.

6. The method of claim 5, wherein providing the particular SDM service via the SDM system includes allocating or increasing storage for the subscriber data for the enterprise entity via the particular SDM service of the plurality of SDM services of the SDM system based on the number of subscribers indicated in the input information.

7. The method of claim 5, wherein the input information further indicates an expiration time for the subscriber data for the enterprise entity.

8. The method of claim 1, wherein the input information further indicates on-premise location information for the one or more on-premise locations of the enterprise entity at which the subscriber data is to be provided for one or more on-premise SDM services of the enterprise entity.

9. The method of claim 1, wherein the subscriber data is Subscriber Identification Module (SIM) data for a plurality of subscribers of the enterprise entity.

10. The method of claim 1, wherein the input information is obtained via at least one of a graphical user interface (GUI) or an application programming interface (API).

11. One or more non-transitory computer readable storage media encoded with instructions that, when executed by a processor, cause the processor to perform operations, comprising:
obtaining, by a subscriber data management (SDM) system, input information indicating SDM services requested for an enterprise entity, wherein the input information includes a multi-tenancy service attribute for the enterprise entity and indicates whether subscriber data for the enterprise entity is to be provided on-premise for the enterprise entity;
identifying, based on the multi-tenancy service attribute included in the input information, a particular SDM service of the SDM system for storing the subscriber data for the enterprise entity from a plurality of SDM service options provided by the SDM system;
deploying the particular SDM service via the SDM system for storing the subscriber data for the enterprise entity; and
deploying one or more on-premise SDM services at each of one or more on-premise locations of the enterprise entity for storing the subscriber data based on determining that the subscriber data is to be provided on-premise for the enterprise entity.

12. The media of claim 11, wherein based on the multi-tenancy service attribute indicating a unique SDM service for storing the subscriber data for the enterprise entity, the deploying includes providing the particular SDM service that is a physically or logically isolated SDM service that is to serve only the subscriber data for the enterprise entity.

13. The media of claim 11, wherein based on the multi-tenancy service attribute indicating a shared SDM service for the subscriber data for the enterprise entity, the deploying includes providing the particular SDM service that is a shared SDM service that is to serve the enterprise entity and one or more other different enterprise entity for a same service provider.

14. The media of claim 11, wherein based on the multi-tenancy service attribute indicating system that there is no multi-tenancy SDM service preference for the enterprise entity, the deploying includes providing the particular SDM service that is to serve the enterprise entity and any other different enterprise entity for any service providers.

15. The media of claim 11, wherein the input information further indicates on-premise location information for the one or more on-premise locations of the enterprise entity at which the subscriber data is to be provided for one or more on-premise SDM services of the enterprise entity.

16. A system comprising:
at least one memory element for storing data; and
at least one processor for executing instructions associated with the data, wherein executing the instructions causes the system to perform operations, comprising:
obtaining, by a subscriber data management (SDM) system, input information indicating SDM services requested for an enterprise entity, wherein the input information includes a multi-tenancy service attribute for the enterprise entity and indicates whether subscriber data for the enterprise entity is to be provided on-premise for the enterprise entity;
identifying, based on the multi-tenancy service attribute included in the input information, a particular SDM service of the SDM system for storing the subscriber data for the enterprise entity from a plurality of SDM service options provided by the SDM system;
deploying the particular SDM service via the SDM system for storing the subscriber data for the enterprise entity; and
deploying one or more on-premise SDM services at each of one or more on-premise locations of the enterprise entity for storing the subscriber data based on determining that the subscriber data is to be provided on-premise for the enterprise entity.

17. The system of claim 16, wherein based on the multi-tenancy service attribute indicating a unique SDM service for storing the subscriber data for the enterprise entity, the deploying includes providing the particular SDM service that is a physically or logically isolated SDM service that is to serve only the subscriber data for the enterprise entity.

18. The system of claim 16, wherein based on the multi-tenancy service attribute indicating a shared SDM service for the subscriber data for the enterprise entity, the deploying includes providing the particular SDM service that is a shared SDM service that is to serve the enterprise entity and one or more other different enterprise entity for a same service provider.

19. The system of claim 16, wherein based on the multi-tenancy service attribute indicating system that there is no multi-tenancy SDM service preference for the enterprise entity, the deploying includes providing the particular SDM service that is to serve the enterprise entity and any other different enterprise entity for any service providers.

20. The system of claim 16, wherein the input information further indicates on-premise location information for the one or more on-premise locations of the enterprise entity at which the subscriber data is to be provided for one or more on-premise SDM services of the enterprise entity.
